(19) United States
(12) Patent Application Publication
(10) Pub. No.: US 2020/0293610 A1
(43) Pub. Date: Sep. 17, 2020

(54) DOCUMENT EDITING APPARATUS AND NON-TRANSITORY COMPUTER READABLE MEDIUM

(71) Applicant: FUJI XEROX CO., LTD., Tokyo (JP)

(72) Inventor: Takuya OKAMOTO, Kanagawa (JP)

(73) Assignee: FUJI XEROX CO., LTD., Tokyo (JP)

(21) Appl. No.: 16/539,470

(22) Filed: Aug. 13, 2019

(30) Foreign Application Priority Data
Mar. 12, 2019 (JP) 2019-044646

(51) Int. Cl. G06F 17/24; G06K 9/00

(52) U.S. Cl. CPC G06F 17/24; G06K 9/00469; G06K 9/00463

(57) ABSTRACT

A document editing apparatus includes a receiver, a processor, and a bundling unit. The receiver is configured to receive an operation of bundling plural documents. The processor is configured to, when the receiver receives the operation of bundling during editing of a part of the plural documents, perform a process for bundling the plural documents. The bundling unit is configured to, when the editing of the part of the plural documents is completed, bring the plural documents into a state in which an editing result of the part of the plural documents is reflected and the plural documents are bundled, using a process result by the processor.

### CROSS-REFERENCE TO RELATED APPLICATIONS

This application is based on and claims priority under 35 USC 119 from Japanese Patent Application No. 2019-044646 filed Mar. 12, 2019.

### BACKGROUND

### (i) Technical Field

The present disclosure relates to a document editing apparatus and a non-transitory computer readable medium.

### (ii) Related Art

In the related art, a method of automatically sharing information between group members is known (see, for example, JP-T-2016-511476).

The method includes the steps of updating information in a member's device and determining whether the information is displayed for sharing with the group members. The updated information, which is displayed for sharing, is automatically compared to a copy of the information at a server in the network. When the updated information is newer than the copy at the server, the updated information is uploaded to the server via a cloud service. When the device is turned on or connected to the network, the device automatically checks with the server whether there is sharable information in the server that is newer than the corresponding copy on the device or whether there is a push message displayed to be sent to the device. The device then synchronizes the copy on the device with the newer information on the server.

Also, a file management system is known (see, for example, JP-A-2004-199401).

The file management system edits and uploads the shared document that a client downloads from the server. At this time, an editing content classification unit classifies the editing content performed on the shared document into the editing content for sharing to be reflected in the shared document uploaded based on an editing level and the local editing content not to be reflected. A difference extraction unit extracts the editing content added by another client for the same shared document downloaded by the client and sends the extracted editing content to the client. A shared document generation processor reflects the already shared editing content and the editing content for sharing in the shared document to generate the uploaded shared document.

Further, a document management apparatus is known as a system of recording a document derivation relationship (see, for example, JP-A-2009-251987).

In the document management apparatus, when an ID-added document including a management ID is operated, the client generates an ID-added document including a newly generated management ID, an original management ID, an operation type, and a document content after the operation, and sends the generated ID-added document to the server. When the operation type of the sent document is an editing, a document registering unit of the server specifies a document of which the operation type is an editing or a registration among the documents corresponding to the ancestors of the document, and checks whether the descendants of the specified document include a document of which the operation type is an editing. Then, when such a document is found, the ID-added document sent from the client is not registered in a document DB and a derivation relationship DB, but the client is warned that the editing is performed ignoring the editing result of another person.

### SUMMARY

Aspects of non-limiting embodiments of the present disclosure relate to a document editing apparatus and a non-transitory computer readable medium capable of obtaining a document in which an editing result is reflected even when plural documents including a document being edited are bundled.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a document editing apparatus including: a receiver configured to receive an operation of bundling plural documents; a processor configured to, when the receiver receives the operation of bundling during editing of a part of the plural documents, perform a process for bundling the plural documents; and a bundling unit configured to, when the editing of the part of the plural documents is completed, bring the plural documents into a state in which an editing result of the part of the plural documents is reflected and the plural documents are bundled, using a process result by the processor.

### BRIEF DESCRIPTION OF THE DRAWINGS

Exemplary embodiment(s) of the present disclosure will be described in detail based on the following figures, wherein:

FIGS. 1A and 1B are block diagrams illustrating an example of a hardware configuration of a document editing system according to a first exemplary embodiment;

FIG. 2 is a block diagram illustrating an example of a functional configuration of the document editing system according to the first exemplary embodiment;

FIG. 3 is a schematic diagram illustrating an example of the configuration of a specific information database according to the first exemplary embodiment;

FIG. 4 is a flowchart illustrating an example of a document editing process according to the first exemplary embodiment;

FIG. 5 is a flowchart illustrating an example of a pre-process according to the first exemplary embodiment;

FIGS. 6A and 6B are a flowchart illustrating an example of a bundling process according to the first exemplary embodiment;

FIG. 7 is a flowchart illustrating an example of a thumbnail display process according to the first exemplary embodiment;

FIG. 8 is a front view illustrating an example of the configuration of a thumbnail display screen before bundling documents according to the first exemplary embodiment;

FIG. 9 is a front view illustrating an example of the configuration of editable pages in an editing screen of the bundled documents according to the first exemplary embodiment;

FIG. 10 is a front view illustrating an example of the configuration of non-editable pages in the editing screen of the bundled documents according to the first exemplary embodiment;

FIG. 11 is a front view illustrating an example of the configuration of the editing screen of the bundled documents according to the first exemplary embodiment;

FIG. 12 is a front view illustrating an example of the configuration of a reflection receiving screen according to the first exemplary embodiment;

FIG. 13 is a front view illustrating an example of the configuration of a non-reflection presenting screen according to the first exemplary embodiment;

FIG. 14 is a front view illustrating an example of the configuration of a deletion receiving screen according to the first exemplary embodiment;

FIG. 15 is a front view illustrating an example of the configuration of a thumbnail display screen after bundling documents according to the first exemplary embodiment; and

FIG. 16 is a flowchart illustrating an example of a document editing process according to a second exemplary embodiment.

### DETAILED DESCRIPTION

### First Exemplary Embodiment

Hereinafter, exemplary embodiments of the present disclosure will be described in detail with reference to the accompanying drawings. Further, in a first exemplary embodiment, descriptions will be made on a case where the present disclosure is applied to a document editing system 90 that includes a document editing apparatus 10 implemented by a server computer or the like, a terminal 20 individually used by each user, and a server 30 implemented by a server computer.

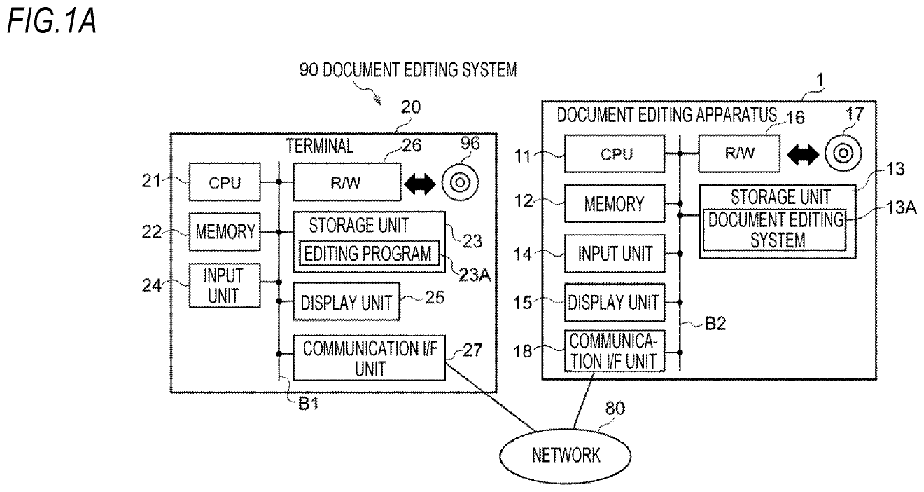

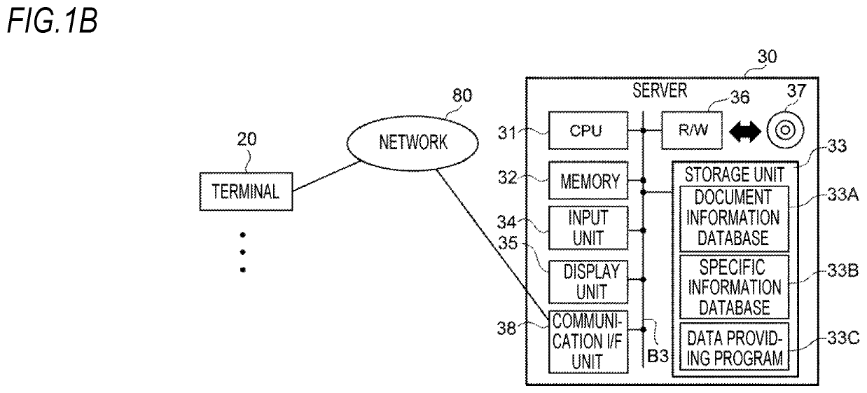

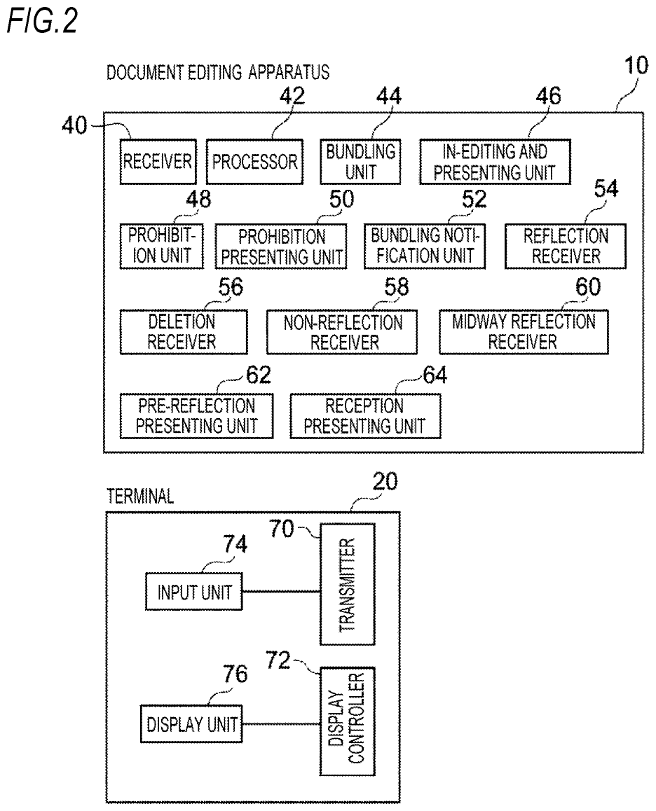

First, the configuration of a document editing system 90 according to the present exemplary embodiment will be described with reference to FIGS. 1A, 1B, and 2. As illustrated in FIGS. 1A and 1B, the document editing system 90 according to the present exemplary embodiment includes a document editing apparatus 10, plural terminals 20, and a server 30, each connected to a network 80 so as to be mutually accessible.

Further, examples of the document editing apparatus 10 include information processing apparatuses such as a personal computer and a server computer. In addition, examples of the terminal 20 include a portable terminal such as a smartphone, a tablet terminal, or a personal digital assistant (PDA, a portable information terminal) and a personal computer.

### (Terminal)

The terminal 20 according to the present exemplary embodiment is a terminal owned by each of plural target persons who use the document editing system 90. The terminal 20 includes a central processor (CPU) 21, a memory 22 as a temporary storage area, a non-volatile storage unit 23, an input unit 24 such as a touch panel, a display unit 25 such as a liquid crystal display, a medium read and write device (R/W) 26, and a communication interface (UF) unit 27. Other terminals 20 also have the same configuration.

The CPU 21, the memory 22, the storage unit 23, the input unit 24, the display unit 25, the medium read and write device 26, and the communication I/F unit 27 are connected to each another via a bus B 1. The medium read and write device 26 reads information written to a recording medium 96 and writes information to the recording medium 96.

The storage unit 23 is implemented by a hard disk drive (HDD), a solid state drive (SSD), a flash memory, or the like. The storage unit 23 as a storage medium stores an editing program 23A that edits or bundles a document stored in the server 30 (to be described later), and executes other instructions.

The editing program 23A is stored in the storage unit 23 by setting the recording medium 96 in which the editing program 23A is written to the medium read and write device 26, and by the medium read and write device 26 reading the editing program 23A from the recording medium 96. The CPU 21 reads the editing program 23A from the storage unit 23 to develop the editing program 23A in the memory 22, and sequentially performs the respective processes that the editing program 23A has. The editing program 23A may be downloaded via the network 80.

As a result, a CPU 31 operates according to the editing program 23A, thereby making it possible to perform an operation of editing a document stored in the server 30 (which will be described later) and an operation of bundling plural documents, using the terminal 20.

### (Document Editing Apparatus)

The document editing apparatus 10 is an apparatus that integrally manages various information handled by the document editing system 90.

The document editing apparatus 10 includes a CPU 11, a memory 12 as a temporary storage area, a non-volatile storage unit 13, an input unit 14 such as a keyboard and a mouse, a display unit 15 such as a liquid crystal display, a medium read and write device 16, and a communication interface (UF) unit 18.

The CPU 11, the memory 12, the storage unit 13, the input unit 14, the display unit 15, the medium read and write device 16, and the communication I/F unit 18 are connected to each another via a bus B2. The medium read and write device 16 reads information written to a recording medium 17 and writes information to the recording medium 17.

The storage unit 13 is implemented by an HDD, an SSD, a flash memory, or the like. The storage unit 13 serving as a storage medium stores a document editing program 13A.

The document editing program 13A is stored in the storage unit 13 by setting the recording medium 17 in which the document editing program 13A is written to the medium read and write device 16 and by the medium read and write device 16 reading the document editing program 13A from the recording medium 17. The document editing program 13A may be downloaded via the network 80. The CPU 11 reads the document editing program 13A from the storage unit 13 to develop the document editing program 13A in the memory 12, and sequentially performs the respective processes that the document editing program 13A has.

### (Server)

The server 30 is an apparatus that integrally manages the documents handled by the document editing system 90 and the state of each of the documents.

The server 30 includes a CPU 31, a memory 32 as a temporary storage area, a non-volatile storage unit 33, an input unit 34 such as a keyboard and a mouse, a display unit 35 such as a liquid crystal display, a medium read and write device 36, and a communication interface (I/F) unit 38.

The CPU 31, the memory 32, the storage unit 33, the input unit 34, the display unit 35, the medium read and write device 36, and the communication I/F unit 38 are connected to each another via a bus B3. The medium read and write device 36 reads information written to a recording medium 37 and writes information to the recording medium 37.

The storage unit 33 is implemented by an HDD, an SSD, a flash memory, or the like. A document information database 33A, a specific information database 33B, and a data supply program 33C are stored in the storage unit 33 as a storage medium. Plural documents are stored in the document information database 33A, and information of each of the document is stored in the specific information database 33B. The data supply program 33C may be downloaded or uploaded via a network 90.

The data supply program 33C is stored in the storage unit 33 by setting the recording medium 37 in which the data supply program 33C is written to the medium read and write device 36, and by the medium read and write device 36 reading the data supply program 33C from the recording medium 37.

The CPU 31 reads the data supply program 33C from the storage unit 33 to develop the data supply program 33C in the memory 32, and sequentially performs the respective processes that the data supply program 33C has.

As a result, the CPU 31 operates according to the data supply program 33C, thereby transmitting data of the document information database 33A and the specific information database 33B to the requested terminal or the document editing apparatus 10.

Next, with reference to FIG. 2, descriptions will be made on the functional configurations of the document editing apparatus 10 and the terminal 20 according to the present exemplary embodiment.

### [Document Editing Apparatus]

The document editing apparatus 10 includes a receiver 40, a processor 42, a bundling unit 44, an in-editing presenting unit 46, a prohibition unit 48, a prohibition presenting unit 50, a bundling notification unit 52, a reflection receiver 54, a deletion receiver 56, a non-reflection presenting unit 58, a midway reflection receiver 60, a pre-reflection presenting unit 62, and a reception presenting unit 64.

The CPU 11 of the document editing apparatus 10 executes the document editing program 13A to function as the receiver 40, the processor 42, the bundling unit 44, the in-editing presenting unit 46, the prohibition unit 48, and the prohibition presenting unit 50. In addition, the CPU 11 of the document editing apparatus 10 executes the document editing program 13A to function as the bundling notification unit 52, the reflection receiver 54, the deletion receiver 56, the non-reflection presenting unit 58, the midway reflection receiver 60, the pre-reflection presenting unit 62, and the reception presenting unit 64.

### (Receiver)

The receiver 40 according to the present exemplary embodiment receives an operation of bundling plural documents in the document information database 33A.

Here, the phrase “bundling plural documents” refers to combining plural documents into a single document. As for a combining method, the page order of the original document may be reflected to be combined for each document, or pages of plural documents may be mixed and combined.

In addition, the phrase “operation of bundling” (bundling operation) will be described by taking, as an example, a case of performing an operation of bundling a document A and a document B. In this case, the phrase “operation of bundling” (bundling operation) refers to an operation of forming a single document in which a document A and a document B are combined.

In the following, a case where plural documents of a document A and a document B are bundled into a single document will be described as an example.

In the present exemplary embodiment, descriptions will be made on, as an example, a case of performing an operation of directly integrating and bundling shared documents stored in the document information database 33A of the server 30, but the present disclosure is not limited to this. For example, after the operator performs the operation of downloading documents stored in the document information database 33A of the server 30 to the terminal 20 and the operation of bundling the documents, the bundled single document may be uploaded to the server 30.

### (Processor)

The processor 42 performs a process for bundling plural documents when a bundling operation is received during editing of a part of the plural documents.

Examples of a process performed by the processor 42 may include a process of generating specific information capable of specifying the document being edited, and a process of generating a provisional document of the document being edited and bundling the provisional document and other documents except the document being edited. In the present exemplary embodiment, a process using a provisional document will be described as an example.

### (Bundling Unit)

When the editing of the document being edited is completed, the bundling unit 44 uses the process result by the processor 42 to form a single document in a state in which the editing result of the document being edited is reflected and bundled.

Examples of the process of the bundling unit 44 include a process of bundling plural documents including a document which is specified by the specific information generated by the processor 42 and which has been edited, into a single document. Further, examples of the process of the bundling unit 44 may include a process of reflecting the editing result in the documents that are bundled into a single document by the processor 42, specifically, the provisional document temporarily bundled. In the present exemplary embodiment, descriptions will be made on, as an example, a process of reflecting the editing result in the provisional documents bundled by the processor 42.

When the process of generating specific information is performed, plural documents are bundled into a single document after the editing of the document being edited is completed. In addition, when the process of generating a provisional document is performed, plural documents including the provisional document are bundled into a single document, and then the editing result is reflected in the bundled document.

Here, the phrase “reflecting the editing result in the provisional document bundled” refers to “replacing the bundled provisional document with the edited document” or “overwriting the edited document on the bundled provisional document”.

### (In-Editing Presenting Unit)

The in-editing presenting unit 46 presents, to the operator who performs a bundling operation, information indicating that the provisional document is being edited.

Here, the term “present” has a concept that includes at least one of display on the display unit 25, presentation by voice output, or presentation by printing.

### (Prohibition Unit and Prohibition Presenting Unit)

The prohibition unit 48 prohibits editing of the provisional document, and the prohibition presenting unit 50 presents information indicating that editing of the provisional document is prohibited when displaying the bundled documents. As a result, the information indicating that the provisional document cannot be edited is presented to the operator who performs the bundling operation, and the editing of the provisional document is prohibited.

### (Bundling Notification Unit)

When the bundled document is formed, the bundling notification unit 52 notifies the editor who edits the document being edited that the document being edited is bundled.

### (Reflection Receiver)

When the editing of the document being edited is completed, the reflection receiver 54 receives an instruction input to the editor as to whether a process of reflecting the editing result in the provisional document is performed. When the reflection receiver 54 receives an instruction input as to performing a process of reflecting the editing result in the provisional document, the bundling unit 44 performs a process of reflecting the editing result in the provisional document.

### (Deletion Receiver)

The deletion receiver 56 receives an instruction input as to whether to delete the edited document when the process of reflecting the editing result in the bundled documents is performed. When an instruction input as to deleting the edited document is received by the deletion receiver, the bundling unit 44 performs a process of deleting the edited document.

### (Non-Reflection Presenting Unit)

When a process of reflecting the editing result in the bundled document cannot be performed, the non-reflection presenting unit 58 presents to the operator who performs the bundling operation, information indicating that the process of reflecting the editing result may not be performed.

### (Midway Reflection Receiver)

The midway reflection receiver 60 receives an instruction input to reflect the editing result which has been ended so far in the bundled document, in a middle of the editing of the document being edited. When the midway reflection receiver 60 receives an instruction input as to reflecting the editing result ended so far in the bundled document, the bundling unit 44 performs a process of reflecting the editing result ended so far in the bundled document.

### (Pre-Reflection Presenting Unit and Reception Presenting Unit)

The pre-reflection presenting unit 62 presents information indicating that the editing result has not yet been reflected. The reception presenting unit 64 presents information indicating that an operation of bundling plural documents is received.

### [Terminal]

The terminal 20 according to the present exemplary embodiment includes a transmitter 70 and a display controller 72. The CPU 21 of the terminal 20 executes the editing program 23A to function as a transmitter 70 and a display controller 72.

The transmitter 70 according to the present exemplary embodiment transmits a bundling operation, a document editing operation, each instruction, a request, or the like according to an input from the input unit 74. Further, the display controller 72 performs a control to display the data sent from the document editing apparatus 10 or the like on a display unit 76.

### (Document Information Database)

Plural documents are stored in the document information database 33A according to the present exemplary embodiment. These documents are shared documents, and the stored documents may be edited by using the terminal 20. Further, by passing through the document editing apparatus 10, for example, an operation of browsing a thumbnail display of reducing and displaying the image of a first page of each document and bundling plural documents may be performed.

### (Specific Information Database)

The specific information database 33B stores information such as the editing status of each document. The information such as the editing status is sequentially updated by the CPU 31 of the server 30.

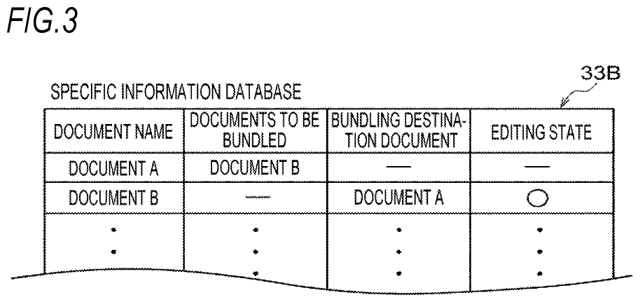

Specifically, as illustrated in FIG. 3, each information of a document name, a document to be bundled, a bundling destination document, and an editing state is stored in the specific information database 33B according to the present exemplary embodiment. The document to be bundled, the bundling destination document, and the editing state indicating the state of each document are stored in association with each sentence name.

### (Document Name)

The document name is information indicating the document name stored in the document information database 33A, and as for the document name, a file name of the document is stored as an example. In the present exemplary embodiment, it is assumed that a document A, a document B, and the like is stored as the file name of the document in a document name field.

### (Document to Be Bundled)

The document to be bundled is information showing a name of a bundled document toward the bundling destination document, and a file name of a document is, for example, stored in the document to be bundled. In the field of the document to be bundled, a name of a bundled document in the document stored in the document name field in the same row is stored, and FIG. 3 represents that the document B is bundled in the document A.

Further, when there is no bundled document in the document stored in the document name field in the same row, the field of the document to be bundled stores no information, and the field becomes blank.

### (Bundling Destination Document)

The bundling destination document is information indicating the document name of the bundling destination document, and the bundling destination document stores, for example, the file name of the document. In the bundling destination document field, a document name of the bundling destination document in which the document stored in the document name field in the same row is bundled is stored, and FIG. 3 represents that the document B is bundled in the document A.

Further, when the documents stored in the document name field in the same row are not bundled into another document, no information is stored in the bundling destination document field, and the field becomes blank.

### (Editing State)

The editing state is information indicating whether the document is being edited, and a mark (“o”) indicating that the document is being edited is stored as an example of the editing state. The character being edited may be displayed in the editing state.

Whether the document stored in the document name field in the same row is being edited is stored in the editing state field, and FIG. 3 represents that the document B is being edited. Further, when the editing of the document B is completed, a mark indicating that the document B is being edited is deleted. Also, when the document B is not edited, the editing state field becomes blank.

### (Operation Explanation)

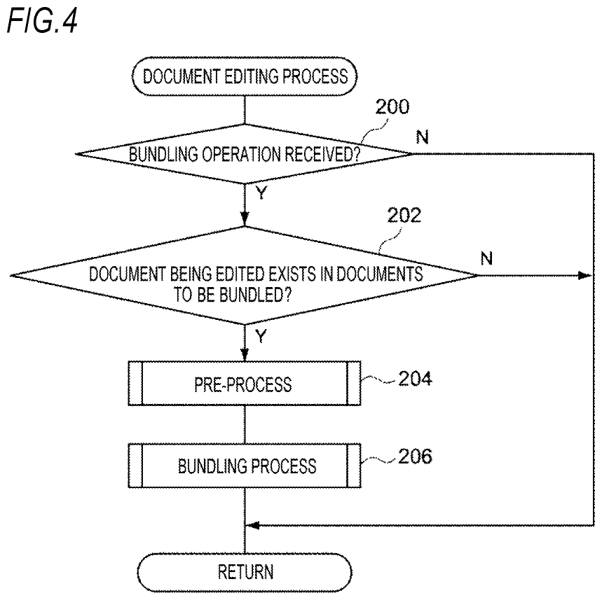

Next, the operation of the document editing system 90 according to the present exemplary embodiment will be described with reference to FIGS. 4 to 15.

First, the operation of the document editing apparatus 10 will be described with reference to FIG. 4. The CPU 11 of the document editing apparatus 10 executes the document editing program 13A to perform the document editing process illustrated in FIG. 4. The document editing process is a process when an operator using the terminal 20 performs an operation of bundling documents stored in the server 30, and a document editing process routine is periodically performed.

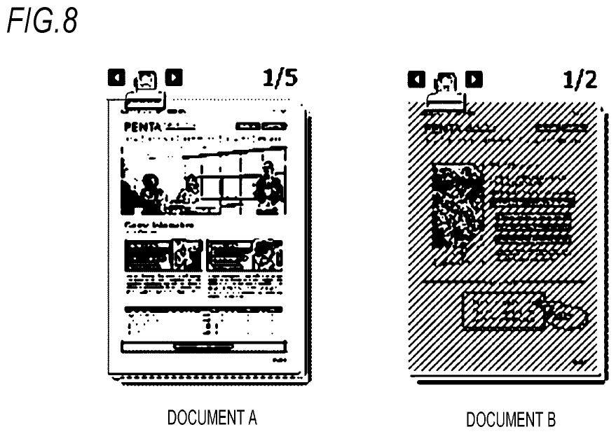

In the following, as illustrated in FIG. 8, descriptions will be made on, as an example, a case in which the document B being edited is bundled in the document A as a bundling operation. In this figure, diagonal lines on the document B displayed with thumbnail indicate that the document B is being edited. Further, a person who performs the bundling operation using the terminal 20 is described as an operator, and a person who edits the document B using the terminal 20 is described as an editor.

In step 200 of the document editing process, the CPU 11 determines whether it has been received that an operation of bundling plural documents is performed, and when not received, the process returns to the main routine.

Here, when the operator using the terminal 20 drags the document B displayed with thumbnail on the display unit 25 and drops the document B on the document A as illustrated in FIG. 8, a request to perform an operation of bundling the document B into the document A is transmitted to the document editing apparatus 10 via the communication I/F unit 27.

When the CPU 11 receives the request to perform the bundling operation, the CPU 11 determines in step 200 that the bundling operation has been received, and determines in step 202 whether the document being edited exists in the documents to be bundled. The data stored in the specific information database 33B of the server 30 is used for this determination.

In step 202, when it is determined that the document being edited does not exist in the documents to be bundled by the CPU, the process returns to the main routine and a normal bundling process is performed. Meanwhile, in step 202, when it is determined that the document being edited exists, the CPU 11 performs a pre-process in step 204 and then performs a bundling process in step 206.

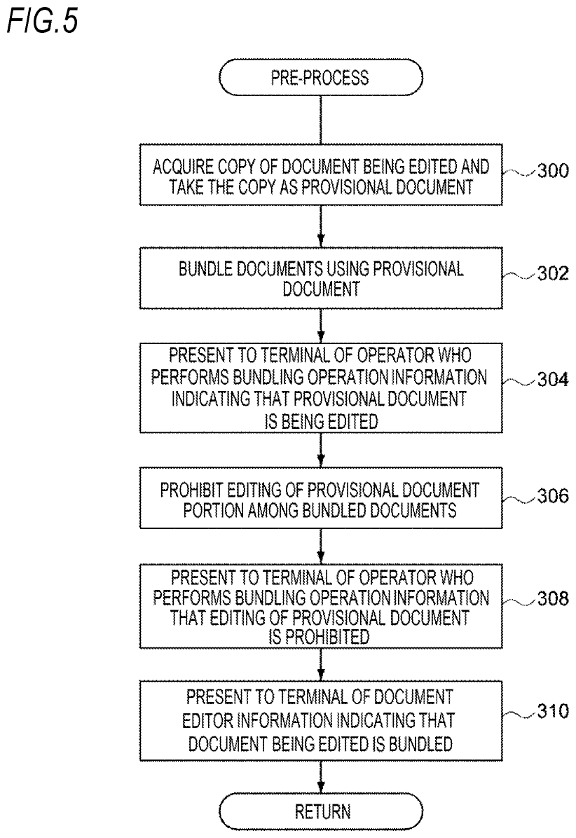

The pre-process of step 204 will be described. As illustrated in FIG. 5, in step 300, the CPU 11 generates a copy of the document B being edited at the present time and acquires the copy as a provisional document, and in step 302, the CPU 11 bundles the provisional document of the document B into the document A by overlapping the acquired provisional document as the next page of the document A. Thus, a process for bundling plural documents is performed.

Further, generally, when bundling plural documents, a copy of the document being edited may be acquired as a provisional document, and the process of bundling may be performed such that the provisional document is positioned at a position corresponding to a page where the document being edited is bundled after editing. The provisional document may also use a copy of the document before editing.

In addition, in step 304, the CPU 11 transmits and presents to the operator's terminal 20 information indicating that the provisional document is being edited. Also, in step 306, the CPU 11 prohibits editing of the provisional document portion in the bundled documents, and in step 308, the CPU 11 transmits and presents to the operator's terminal 20 information indicating that editing of the provisional document portion in the bundled documents is prohibited.

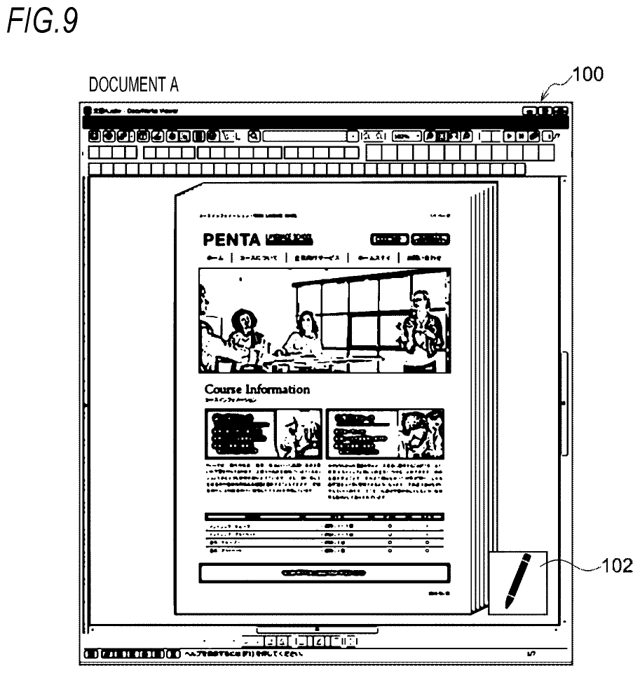

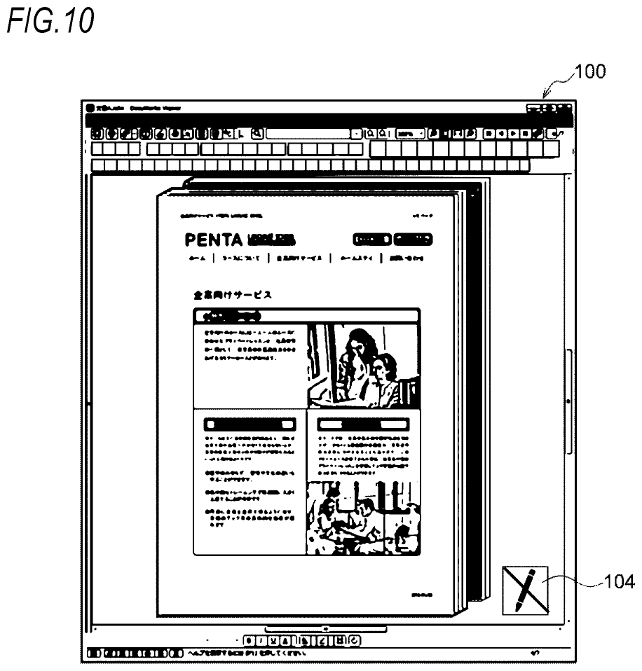

FIGS. 9 and 10 are diagrams illustrating an editing screen 100 displayed on the display unit 25 of the operator's terminal 20. As illustrated in FIG. 9, an editable mark 102 indicating that editing is possible is displayed at the lower right of the editing screen 100 representing the page of the editable document A among the bundled documents. Further, as illustrated in FIG. 10, an editing prohibition mark 104 indicating that editing is prohibited is displayed at the lower right of the editing screen 100 representing the page of the provisional document for which editing is prohibited among the bundled documents. Also, the editing prohibition mark 104 indicates that the provisional document is being edited.

Further, as illustrated in FIG. 5, the CPU 11 in step 310 transmits and presents to the terminal 20 of the editor who is editing the document B information indicating that the document being edited is bundled, and the bundling process is performed in step 206 of the document editing process illustrated in FIG. 4.

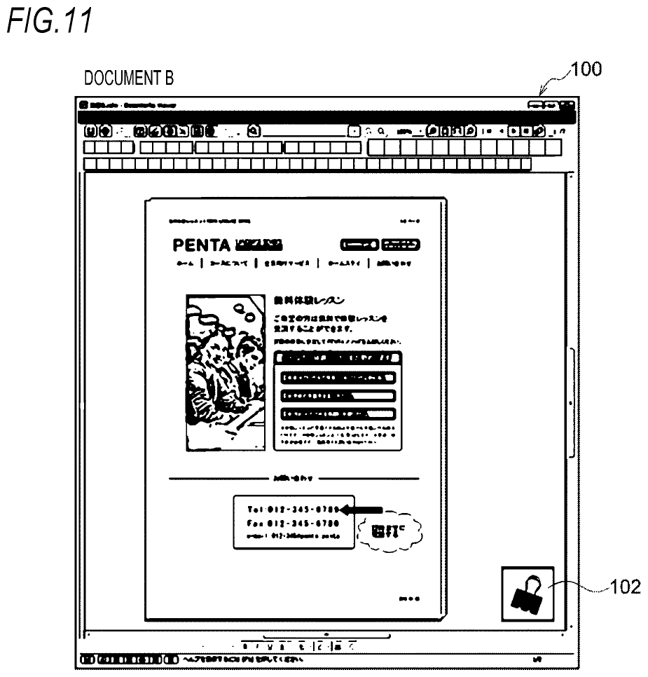

FIG. 11 is a diagram illustrating the editing screen 110 displayed on the display unit 25 of the terminal 20 of the editor who edits document B, and a bundling mark 112 indicating that the documents being edited are bundled is displayed at the lower right of the editing screen 110.

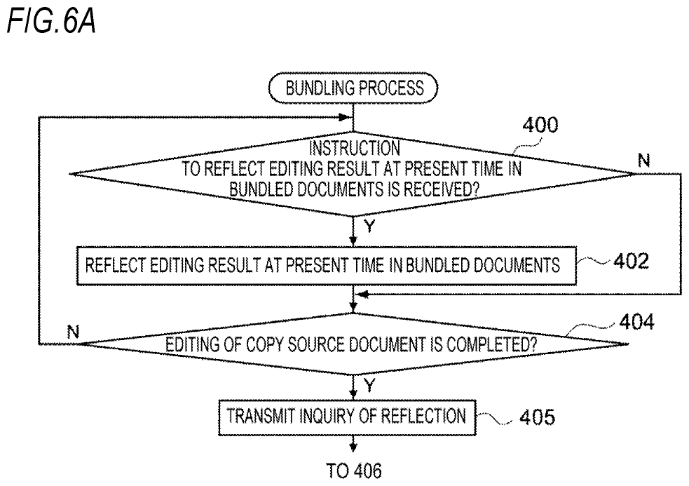

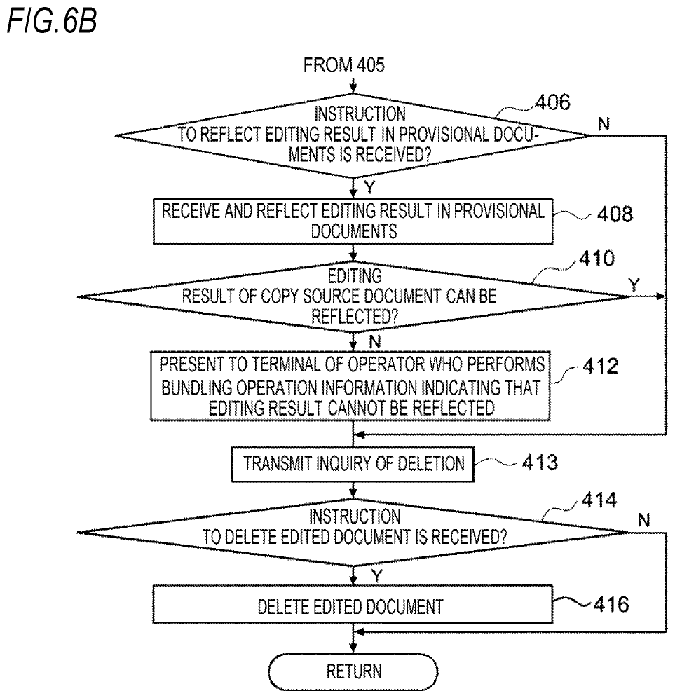

Next, the bundling process of step 206 will be described. As illustrated in FIG. 6A, in step 400, the CPU 11 determines whether an instruction to reflect the editing result which has been ended so far in the bundled document has been received from the editor's terminal 20 in a middle of the editing of the document B.

When it is determined that the instruction to reflect has not been received, step 404 is executed, whereas, when it is determined that the instruction to reflect has been received, step 402 is executed. In step 402, the CPU 11 receives the current editing result from the server 30, and reflects the received editing result in the bundled provisional documents.

In step 404, the CPU 11 determines whether the editing of the document B which is a copy source is completed, from the change in the editing state of the specific information database 33B.

The timing at which the editing of the document B is ended may be reworded as the timing at which the content of the document B is stored or the timing at which the document B is closed.

In step 404, when the CPU 11 determines that the editing of the document B is not completed, the process returns to step 400, and the determination of step 400 and the process of step 402 are repeated.

Meanwhile, in step 404, when the CPU 11 determines that the editing of the document B is completed, the CPU 11 in step 405 transmits data that inquires whether to reflect the editing result, to the editor's terminal 20. Then, in step 406, the CPU 11 determines whether an instruction to perform a process of reflecting the editing result of the document B in the provisional document has been received from the editor's terminal 20.

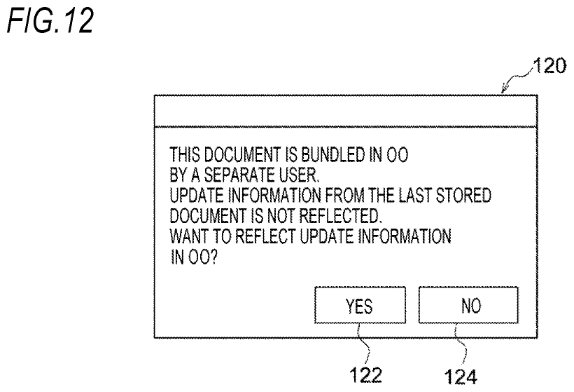

FIG. 12 is a diagram illustrating a reflection receiving screen 120 displayed on the editor's terminal 20, and the reflection receiving screen 120 displays a “Yes button” 122 selected when a reflection is made and a “No button” 124 selected when no reflection is made. When the editor selects the “Yes button” 122, an instruction to reflect is transmitted to the document editing apparatus 10, and when the “No button” 124 is selected, an instruction not to reflect is transmitted to the document editing apparatus 10.

Further, only the document name of the bundled document may be displayed on “OO” in the reflection receiving screen, and information correctly indicating the location of the document such as a path or a URL indicating the storage location of the file may be displayed thereon.

In step 406 of FIG. 6B, when it is determined that an instruction not to reflect the editing result of the document B in the provisional document has been received, the CPU 11 executes step 413, and when it is determined that an instruction to reflect the editing result of the document B in the provisional document has been received, the CPU 11 executes step 408. In step 408, the CPU 11 receives the editing result of the document B from the server 30, and reflects the editing result in the bundled provisional documents.

Here, as an example in which the editor of the document B does not reflect the editing result in the provisional document, there may be a separate approver of the edited content of document B, and it is necessary to obtain a confirmation or an approval before generating the bundled document in the document A.

In step 410, the CPU 11 determines whether the process of reflecting the editing result of the document B in the bundled provisional documents can be performed. In step 410, when it is determined that the editing result can be reflected in the provisional documents, the CPU 11 executes step 413, and when it is determined that the editing result cannot be reflected in the provisional documents, the CPU 11 executes step 412.

In step 412, the CPU 11 transmits to the operator's terminal 20 that the process of reflecting the editing result cannot be performed. The reason why the process of reflecting the editing result cannot be performed includes a case where the document A cannot be referred to for reasons such as deletion or movement.

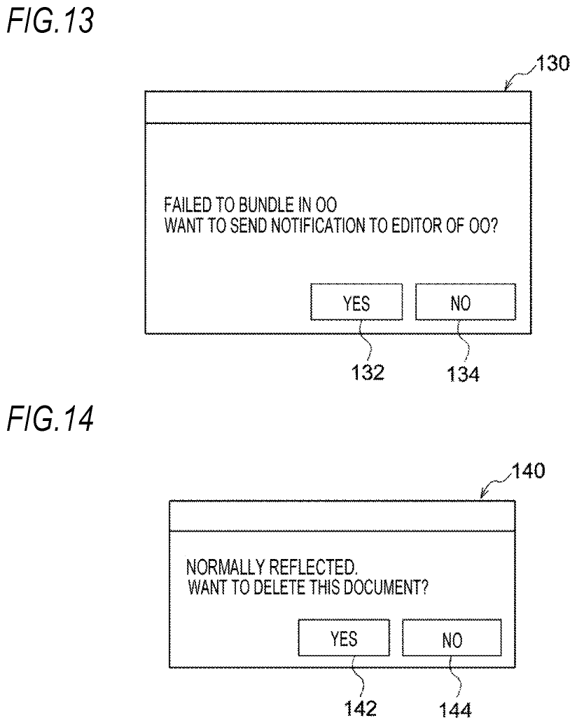

FIG. 13 is a diagram illustrating a non-reflection presenting screen 130 displayed on the operator's terminal 20, and information indicating that the process of reflecting the editing result cannot be performed is presented to the operator.

The non-reflection presenting screen 130 displays a “Yes button” 132 selected when contacting the editor who is editing document B, and a “No button” 134 selected when not contacting the editor. When the operator selects the “Yes button” 132, information indicating contact with the editor is transmitted to the document editing apparatus 10, and when the “No button” 134 is selected, information indicating no contact with the editor is transmitted to the document editing apparatus 10.

For example, when information indicating contact with the editor is transmitted to the document editing apparatus 10, the document editing apparatus 10 presents to the editor information indicating that the process of reflecting the editing result cannot be performed by sending an e-mail or the like. In addition, when information indicating no contact with the editor is transmitted to the document editing apparatus 10, the document editing apparatus 10 proceeds to step 414 illustrated in FIG. 6B. The process of sending an e-mail to the editor is an example, and the editor may be contacted by another method.

In addition, when information on who did what and when for which document is sequentially stored in the server 30, it is possible to send a notification using an e-mail or the like to the person who last handles the document A from the stored information.

In step 413, the CPU 11 transmits the data editor's terminal 20 to inquire about whether the document B needs to be deleted. Then, in step 414, the CPU 11 determines whether it has been received from the editor's terminal 20 that the process of deleting the edited document B is performed.

FIG. 14 is a diagram illustrating a deletion receiving screen 140 displayed on the editor's terminal 20, and the deletion receiving screen 140 displays a “Yes button” 142 selected when deleting a document B and a “No button” 144 selected when not deleting document B. When the editor selects the “Yes button” 142, an instruction to delete the document B is transmitted to the document editing apparatus 10, and when the “No button” 144 is selected, an instruction not to delete the document B is transmitted to the document editing apparatus 10.

In step 414 illustrated in FIG. 6B, when the CPU 11 determines that information indicating that the edited document B is not deleted has been received, the process returns to the document editing process illustrated in FIG. 4, and when the CPU 11 determines that information indicating that the edited document B is deleted has been received, step 416 is executed.

In step 416, the CPU 11 performs a process of deleting the document B stored in the server 30, and returns to the document editing process.

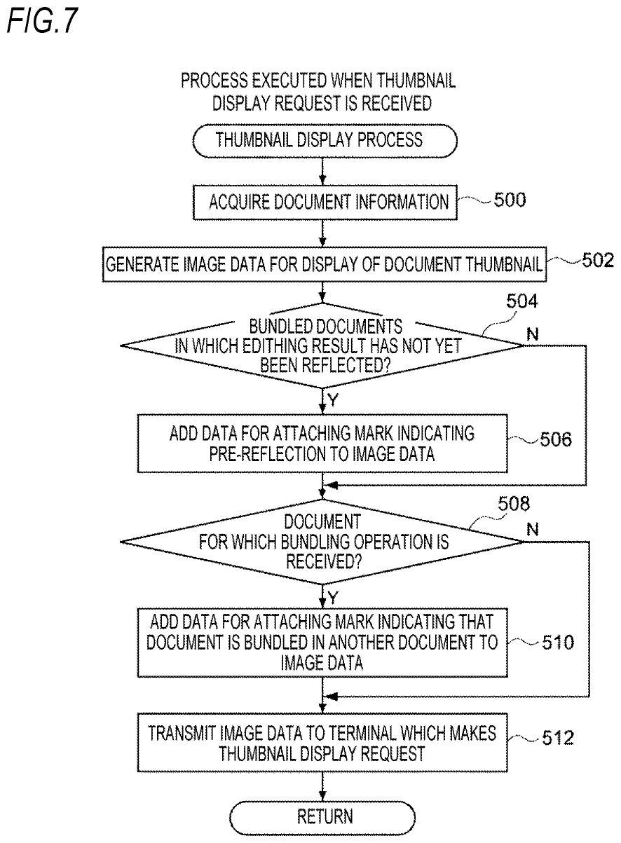

Next, a thumbnail display process will be described with reference to FIG. 7.

The thumbnail display process is an interrupt process that is performed when the CPU 11 of the document editing apparatus 10 receives a thumbnail display request from any of the terminals 20 during the document editing process illustrated in FIG. 4. The thumbnail display request may be made from the terminals 20 of all users who may browse the document stored in the server 30.

In step 500, the CPU 11 acquires document information of a document stored in the specific information database 33B of the server 30, and in step 502, the CPU 11 generates image data for thumbnail display of the document.

In step 504, the CPU 11 determines whether the document is a bundling destination of a document in which the document is bundled, and whether the bundled documents include a document in which the editing result has not yet been reflected, based on the document information from the specific information database 33B. In step 504, when the CPU 11 determines that a document in which the editing result has not yet been reflected is not included, the process proceeds to step 508. When the CPU 11 determines that a document in which the editing result has not yet been reflected is included, step 506 is executed.

In step 506, the CPU 11 adds data for adding a mark indicating that the bundled documents include a document in which the editing result has not yet been reflected, to the above-described image data.

In step S508, the CPU 11 determines whether the document is a document to be bundled for which a bundling operation is received based on the document information of the specific information database 33B. In step 508, when it is determined that the document is not a document to be bundled, the CPU 11 executes step 512, and when it is determined that the document is a document to be bundled, the CPU 11 executes step 510.

In step 510, the CPU 11 adds data for adding a mark indicating that the document is bundled in another document to the above-described image data.

In step 512, the CPU 11 transmits the image data to the terminal 20 which has made a thumbnail display request, and returns to the called routine.

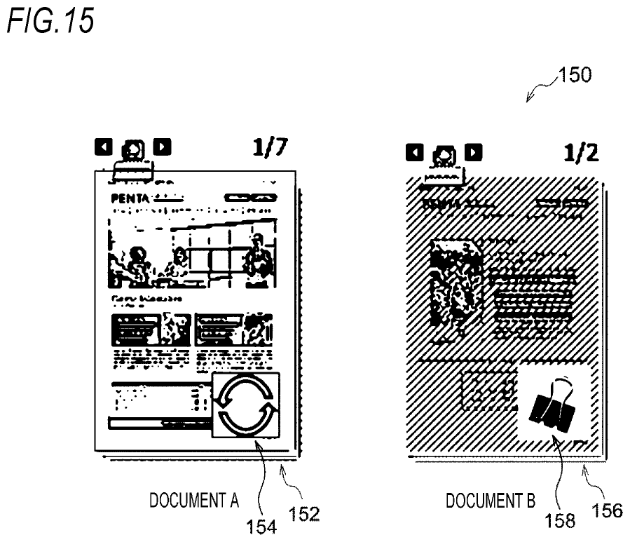

FIG. 15 is a diagram illustrating a thumbnail display screen 150 displayed on the display unit 25 of the terminal 20 to which the image data has been transmitted, and a mark 154 indicating that a document in which the editing result has not yet been reflected is included is attached on a thumbnail display 152 of the document A which is the bundling destination document. Here, the editing result may be configured to be reflected in the provisional document by selecting the mark 154.

Further, a mark 158 indicating that the bundling operation is received and the document B is bundled in another document is attached on a thumbnail display 156 of the document B which is a document to be bundled.

### (Operation and Effects)

As described above, in the present exemplary embodiment, even when plural documents including a document being edited are bundled, a document in which the editing result is reflected may be obtained.

In addition, by performing a process for bundling using a provisional document, it becomes possible to reduce the effort for generating specific information as compared to a case where specific information capable of specifying a part of the documents is temporarily generated.

Furthermore, since the information indicating that the provisional document in the bundled documents is being edited is presented to the operator who performs the bundling operation, it becomes possible to make the operator know that the provisional document is being edited.

Further, since the editing of the provisional documents in the bundled documents is prohibited, it becomes possible to prevent that a part of the documents are edited into different contents.

Furthermore, since presented is the information indicating that the editing of the provisional documents is prohibited, it becomes possible to make the operator know the editing prohibition state.

Further, since the editor who edits the document is notified that the document being edited is bundled, it becomes possible to make the editor know that the document being edited is bundled.

Furthermore, when an instruction to reflect the editing result in the provisional document is received, the process of reflecting the editing result is performed, so that it becomes possible to specify whether the editing result is to be reflected.

Further, when an instruction to delete the edited document is received, the process of deleting the document is performed, so that it becomes possible to specify whether the document for which editing has been completed is to be deleted.

Furthermore, when it is not possible to reflect the editing result in the bundled documents, information indicating that a process of reflecting the editing result cannot be performed is presented to the operator who performs the bundling operation. Thus, it becomes possible to make the operator know that the editing result cannot be reflected.

In addition, when an instruction to reflect the editing result ended so far in the bundled documents has been received during editing of a document, the editing result ended so far is reflected in the bundled documents. Therefore, it becomes possible to reflect the edited content in the middle of editing, in the bundled documents.

Furthermore, since it is possible to present the information indicating that the editing result has not yet been reflected, it becomes possible to know that the editing result has not yet been reflected.

Further, since the information indicating that an operation of bundling plural documents has been received can be presented, it becomes possible to know that an operation to bundle plural documents has been received.

### Second Exemplary Embodiment

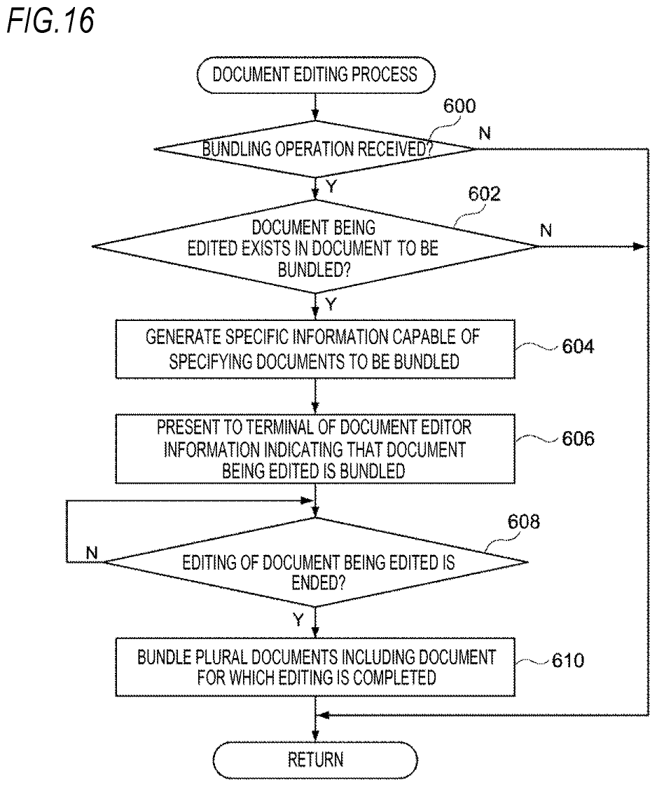

FIG. 16 is a flowchart illustrating a document editing process that is periodically performed according to a second exemplary embodiment, and represents a modification of the first exemplary embodiment.

That is, in step 600 of the document editing process, the CPU 11 determines whether it has been received that the operation of bundling plural documents is performed, and when not received, the process returns.

In step 600, when it has been received that the bundling operation is performed, the CPU 11 determines in step 602 whether the document being edited exists in the documents to be bundled. In step 602, when it is determined that the document being edited does not exist in the documents to be bundled, the CPU 11 returns to the called routine and performs a normal bundling process, and when it is determined that the document being edited exists, step 604 is executed.

In step 604, the CPU 11 generates specific information capable of specifying the bundled documents. As an example of such information, there is a method of associating the file name of document B, which is a document to be bundled, with the document A of a bundling destination and storing the file name in the storage unit 33 of the server 30.

In step 606, the CPU 11 transmits and presents to the terminal 20 of the editor who is editing the document B information indicating that a document being edited is bundled. In step 608, the CPU 11 monitors the change in the editing state of the specific information database 33B of the server 30, and waits for the end of editing of the document B being edited.

Then, when the editing of the document B being edited is completed, in step 610, the CPU 11 bundles the document B for which editing is completed into the document A, and returns to the main routine in a state in which the editing result of the document being edited is reflected and plural documents are bundled.

### (Operation and Effects)

In the present exemplary embodiment, even when plural documents including the document being edited are bundled, it is possible to obtain a document in which the editing result is reflected.

Further, specific information capable of specifying the document being edited is generated, and when editing of the document specified by the generated specific information is completed, plural documents are bound. For this reason, it becomes possible to reduce the effort for reflecting the editing result, as compared with the case of reflecting the editing result after bundling the provisional documents of the document being edited.

In addition, when an operation of bundling documents is received, the editor who edits the document being edited is notified that the document being edited is bundled. Therefore, it becomes possible to make the editor know that the document being edited is bundled.

Further, in the respective exemplary embodiments, various processors described below may be used as a hardware structure of a processor that performs each process of the respective units described above.

The various processors include a dedicated electric circuit or the like which is a processor having a circuit configuration specially designed to perform a specific process of a programmable logic device (PLD), an application specific integrated circuit (ASIC), or the like, which is a processor capable of changing the circuit configuration after manufacturing a field-programmable gate array (FPGA) or the like, in addition to a CPU which is a general-purpose processor that executes software (programs) and functions as a processor as described above.

The processor may be implemented by one of these various types of processors, or a combination of two or more processors of the same or different types (for example, a combination of plural FPGAs or a combination of a CPU and an FPGA). Also, the processor may be implemented by a single processor.

As an example in which the processor is implemented by a single processor, first, as represented by computers such as clients and servers, there is a form in which one processor is implemented by a combination of one or more CPUs and software, and the processor functions as a processor. Second, as represented by a system on chip (SoC) or the like, there is a form using a processor that implements the functions of the entire system including a processor with one integrated circuit (IC) chip. Thus, the processor is implemented by one or more of the above-described various processors as a hardware structure.

Furthermore, as for a hardware structure of these various processors, more specifically, an electrical circuit in which circuit elements such as semiconductor elements are combined (circuitry) may be used.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A document editing apparatus comprising:
a receiver configured to receive an operation of bundling plural documents;
a processor configured to, when the receiver receives the operation of bundling during editing of a part of the plural documents, perform a process for bundling the plural documents; and
a bundling unit configured to, when the editing of the part of the plural documents is completed, bring the plural documents into a state in which an editing result of the part of the plural documents is reflected and the plural documents are bundled, using a process result by the processor.

2. The document editing apparatus according to claim 1, wherein
the process by the processor is a process of generating specific information capable of specifying the part of the plural documents, and
the bundling unit bundles the plural documents including the part of the plural documents which is specified by the specific information generated by the processor and for which the editing is completed, so that the plural documents are bundled in a state in which the editing result of the part of the plural documents is reflected.

3. The document editing apparatus according to claim 2, further comprising:
a notification unit configured to, when the receiver receives the operation of bundling, notify an editor who edits the part of the plural documents that the document being edited is bundled.

4. The document editing apparatus according to claim 1, wherein
the process by the processor is a process of
generating a provisional document of the part of the plural documents, and
bundling the provisional document and the plural documents excluding the part of the plural documents, and
the bundling unit performs a process of reflecting the editing result in the documents bundled by the processor, so that the plural documents are bundled in a state in which the editing result of the part of the documents is reflected.

5. The document editing apparatus according to claim 4, further comprising:
an in-editing presenting unit configured to present to an operator who performs the operation of bundling, information indicating that the provisional document is being edited.

6. The document editing apparatus according to claim 4, further comprising:
a prohibition unit configured to prohibit editing of the provisional document.

7. The document editing apparatus according to claim 6, further comprising:
a prohibition presenting unit configured to, when the bundled documents are displayed, present information indicating that the editing of the provisional document is prohibited.

8. The document editing apparatus according to claim 4, further comprising:
a bundling notification unit configured to, when the bundled documents are formed, notify an editor who edits the part of the plural documents, that the document being edited is bundled.

9. The document editing apparatus according to claim 4, further comprising:
a reflection receiver configured to receives an instruction input as to whether to perform the process of reflecting the editing result in the provisional document when the editing of the part of the plural documents is completed, wherein
when the reflection receiver receives the instruction input to perform a process of reflecting the editing result in the provisional document, the bundling unit performs the process of reflecting.

10. The document editing apparatus according to claim 4, further comprising:
a deletion receiver configured to, when the process of reflecting the editing result in the bundled documents is performed, receive an instruction input as to whether to perform a process of deleting the part of the plural documents after the editing, wherein
when the deletion receiver receives the instruction input to perform the process of deleting the part of the plural documents, the bundling unit performs the process of deleting.

11. The document editing apparatus according to claim 4, further comprising:
a non-reflection presenting unit configured to, when the process of reflecting the editing result in the bundled documents cannot be performed, present to an operator who performs the operation of bundling, information indicating that the process of reflecting the editing result cannot be performed.

12. The document editing apparatus according to claim 4, further comprising:
a midway reflection receiver configured to receive an instruction input to reflect the editing result which has been ended so far in the bundled documents, in a middle of the editing of the part of the plural documents, wherein
when the instruction input to reflect the editing result which has been ended so far in the bundled documents is received, the bundling unit performs the process of reflecting.

13. The document editing apparatus according to claim 4, further comprising:
a pre-reflection presenting unit configured to present information indicating that the editing result has not yet been reflected.

14. The document editing apparatus according to claim 4, further comprising:
a reception presenting unit configured to present information indicating that the operation of bundling the plural documents is received.

15. A non-transitory computer readable medium storing a program causing a computer to execute a document editing process, the document editing process comprising:
receiving an operation of bundling plural documents;
when the operation of bundling is received during editing of a part of the plural documents, performing a process for bundling the plural documents; and
when the editing of the part of the plural documents is completed, bringing the plural documents into a state in which an editing result of the part of the plural documents is reflected and the plural documents are bundled, using a result of the process for bundling the plural documents.

16. A document editing apparatus comprising:
means for receiving an operation of bundling plural documents;
means for, when the operation of bundling during editing of a part of the plural documents is received, performing a process for bundling the plural documents; and
means for, when the editing of the part of the plural documents is completed, bringing the plural documents into a state in which an editing result of the part of the plural documents is reflected and the plural documents are bundled, using a result of the process for bundling the plural documents.
